(19) United States
(12) Patent Application Publication
(10) Pub. No.: US 2019/0137357 A1
(43) Pub. Date: May 9, 2019

(54) SYSTEM AND METHOD OF SELECTING AND IDENTIFYING FIELD DEVICES

(71) Applicant: Bürkert Werke GmbH & Co. KG, Ingelfingen (DE)

(72) Inventors: Franziska MAIER, Karlsruhe (DE); Johannes BAUER, Waldbronn (DE); Claudius HAGEN, Ingelfingen (DE)

(21) Appl. No.: 16/120,512

(22) Filed: Sep. 4, 2018

(30) Foreign Application Priority Data
Sep. 5, 2017 (EP) 17 189 469.4

(51) Int. Cl. G01M 13/00; G01D 18/00

(52) U.S. Cl. CPC G01M 13/00; G01D 18/00

(57) ABSTRACT

A system comprises a cluster of field devices that each have a signal generator assigned to the respective field device. The system includes a communication interface and a data processing device for the provision of system values, diagnostic values and/or process values. The system is configured to selectively choose at least one corresponding system and/or diagnostic value and/or process value of the respective field devices on the basis of a common selection criterion. The system is further configured to determine status information for the respective field device on the basis of the at least one respectively selected system and/or diagnostic value and/or process value and to output the status information using the associated signal generator. The invention further relates to an appropriate method of selecting and identifying field devices from a plurality of field devices.

### CROSS-REFERENCE TO RELATED APPLICATIONS

This application claims priority to EP 17 189 469.4, filed 5 Sep. 2017.

### FIELD OF THE INVENTION

The invention relates to a system and to a method of selecting and identifying field devices.

### BACKGROUND OF THE INVENTION

Field devices are technical devices in the field of automation engineering. Field devices include actuators (such as valves, controlling elements, motors) and sensors (such as flowmeters, temperature sensors, pH sensors).

The field devices are usually connected to a control and guidance system. The communication between the field devices and the control and guidance systems usually runs via a field bus. In the mean time, other network technology such as real-time capable Ethernet is however increasingly used instead of a field bus.

In industrial plants, a process is in this way monitored, open-loop and closed-loop controlled by the control and guidance system. The sensors determine controlled variables such as temperature, pressure and flow. The field device then transmits these controlled variables via a field bus or another communication channel to the control and guidance system. On the basis of the controlled variables, the latter then calculates manipulated variables using process-specific requirements, which are transmitted to the field devices, in particular to the actuators. The actuators act on the open-loop or closed-loop controlled production process in accordance with the manipulated variables.

It is immediately apparent that errors or failures both in the determination of the controlled variables and in the translation of the manipulated variables into an intervention in the production process are highly relevant to the quality of the process result. In other words, one single defective field device, be it a sensor or an actuator, may have serious and devastating effects.

Accordingly, high demands are made on the field devices with regard to quality, robustness and availability. Huge technical efforts are therefore made to reduce the risk of malfunctions or at least to be able to recognize and signalize a defect at an early stage. Huge efforts are also often made concerning the maintenance of the field devices.

Downtimes (which are partially very expensive) occur every time the maintenance or the exchange of a field device cannot take place in a running process.

Document DE 20 2013 103 332 U1 discloses a field device having a display and a separate status annunciator. Apart from process data, it is also possible to represent the operating state of the field device in a clear and easily comprehensible manner. A person charged with the monitoring or maintenance can reliably recognize the operating state of the field device already with a glimpse. Malfunctions and faults in the process flow are in this way minimized.

Documents DE 10 2013 113 726 A1, DE 10 2013 113 725 A1 and DE 10 2013 113 728 A1 also disclose field devices having a separate status annunciator for representing the operating state of the field devices. More specifically, fluid control heads of a fluid controlling or fluid measuring device each having a circumferential luminous ring are involved here.

European patent specification EP 1 486 841 B1 describes a method of retrieving the field device status of a field device using a pocket-size handheld transmitter. It is in this way possible to indicate a service technician whether the field device has a malfunction, even if the field device is difficult to access. The perfect functioning of the field device is signalized by a blinking of the field device display.

### SUMMARY OF THE INVENTION

An object of the invention is to provide a system and a method of selecting and identifying field devices from a plurality of field devices. Further objects will result from the descriptions below.

According to one aspect, the system comprises a cluster (a plurality) of field devices. The number of the field devices of the cluster may advantageously be larger than two, further advantageously larger than three. One signal generator may be assigned to each of the field devices. The signal generator is advantageously directly connected to the field device or attached thereto. The signal generator is thus advantageously located in the place of the field sensor. The signal generator may, for example, be an optical signal generator, such as a luminous ring, a luminous strip, a signaling column (multiple lamp), (colored) LEDs, or a display. The signal generator may also be an acoustic signal generator. Combinations thereof are also possible, for example a multiple lamp having an integrated sound generator module. Other forms of signal generators are also conceivable, for example those giving a haptic feedback (vibration modules) or, for example, a web server which provides indicating information but does not represent such information itself. However, the respective signal generator is preferably unambiguously and directly assigned to one single field device and is in particular directly connected or attached thereto. Optical signal generators in the form of luminous elements (LED etc., e.g.) are therefore particularly advantageous.

According to a further aspect, the field devices each have at least one communication interface. The field devices can exchange information (data) with each other and/or with a super-ordinated control and guidance system via the communication interface. The field devices can in particular be linked to a common bus system or network via the communication interface. The field devices of the cluster of field devices are in particular connected to each other by a bus system or a network. Diagnostic interfaces are also communication interfaces within the meaning of the specification. The same applies, for example, to a web server via the service of which it is possible to communicate with the field device.

According to a further aspect, the field devices each have a data processing device. The data processing device is configured to process and provide data, in particular system values, diagnostic values and/or process values internally (for example for programs, processes, services, routines) and/or externally (for example via the communication interface).

System values, for example, describe the type of the field device, the firmware version, the date of manufacture, the date of putting into operation, the date of the last maintenance or other values describing the field device or the configuration thereof.

Diagnostic values are such values which permit a conclusion to be drawn about the state (for example within the meaning of the health of the apparatus). This includes, for example, the number of hours of operation, the cumulated travels of actuators, the number of openings and closures of a valve, or a value of the wear for a valve membrane. It is in some cases not possible to unambiguously assign values to the system values or the diagnostic values. An artificial distinction between the categories is then often not useful.

Apart from the system values and the diagnostic values, the process values form an important category. Substantially all values describing the process itself belong to the process values. This particularly includes all manipulated and controlled variables or also a temperature, a pH value, a flow value (mass flow) or the valve position.

According a further aspect, the system is configured to selectively choose at least one corresponding system and/or diagnostic value and/or process value of the respective field devices on the basis of a common selection criterion. The term “corresponding” in the previous sentence generally relates to the common selection criterion. The common selection criterion can be understood as a superordinate question. The system is thus configured to select those values for the respective field devices which have a particular meaning with regard to the superordinate question of the common selection criterion.

Corresponding values may, but need not be of the same type and of the same origin. It is rather relevant that the corresponding values are meaningful with regard to the common selection criterion.

For two identical or comparable field devices of the same type, the same value is usually selected on both field devices depending on the selection criterion. For field devices of different types, the corresponding values may also be of completely different origins.

For example, while the cumulated travel of a spindle may be regarded as particularly meaningful for a specific type of actuator with regard to a predicted residual service life, it is possible that a chemical sensor time-dependently degenerates already due to the contact with the process fluid. In this case, the corresponding diagnostic values would thus involve, on the one hand, the cumulated travel and, on the other hand, the period of time since the putting into operation.

Another example for the common selection criterion could be the timeliness of the firmware. It is immediately apparent here that completely different versions of the firmware may be up to date for different types of field devices.

Furthermore, the selection criterion may also involve a superordinate question which relates to the process values, for example. Depending on the field device, the appropriate process values may, for example, be a temperature (temperature sensor), a flow (flowmeter), a pH value (pH value sensor) or a valve position (valve).

According to a further aspect, the system is configured to determine status information for the respective field device on the basis of the at least one selected system and/or diagnostic value and/or process value of the respective field devices and in accordance with the selection criterion, and to output the status information using the assigned signal generator.

In this way, depending on the common selection criterion and on the basis of the respective corresponding system and/or diagnostic values and/or process values, cluster of field devices are selectively chosen and individually made identifiable within the cluster using the status information output by the respective signal generator.

The display advantageously occurs for all field devices of the cluster simultaneously or sequentially such that the status information is quickly and immediately perceivable for the entire cluster (so-called “cluster-signaling” or “cluster-lamps” for example in case of optical signals).

According to an advantageous aspect, the system may comprise a diagnostic apparatus. The diagnostic apparatus may include a data processor, a communication interface for the communication with the field devices, and a human-machine interface.

The diagnostic apparatus may be configured to exchange information with the respective field devices and in particular to selectively choose the corresponding system and/or diagnostic values and/or process values of the respective field devices on the basis of user inputs at the human-machine interface.

The diagnostic apparatus may be a superordinate control or one of the field devices of the system or of the cluster. Alternatively, the diagnostic apparatus may also be a PC, a laptop, a tablet-PC or a similar handheld device having a configuration tool (such as the Bürkert Communicator, for example).

According to a further aspect, the system may comprise a diagnostic program code. The diagnostic program code may be configured to be executed by the data processor of the diagnostic apparatus and/or by the data processing device of one of the field devices.

The diagnostic program code may further be configured to retrieve, process and/or change the at least one selected system and/or diagnostic value and/or process value of each field device of the field device cluster.

Furthermore, the diagnostic program code may be configured to determine the status information for the respective field device from the at least one selected system and/or diagnostic value and/or process value of each field device of the field device cluster.

The diagnostic program code can include processing instructions, data structures and/or parameters.

In other words, the diagnostic program code can assign corresponding status information to the system and/or diagnostic values and/or process values of a field device on the basis of a set of regulations.

Status information may advantageously be made perceivable as color values of an illuminated display. The status information within the system may correspondingly involve output instructions for the control of the respective signal generators of the field devices.

Advantageously, it results therefrom that status information are made quickly and immediately recognizable for an entire cluster of field devices, the location/position of the field devices becoming at the same time immediately apparent.

According to a further advantageous aspect, the diagnostic apparatus may be configured to create the diagnostic program code on the basis of the user inputs at the human-machine interface or to select it from a plurality of diagnostic program codes. Diagnostic program codes may be created in a script language such as Lua, or in a compilable language.

The diagnostic apparatus may, for example, parametrize a template-based master of the diagnostic program code using the user inputs and compile it in a machine-executable code (for example a binary code).

According to a further advantageous aspect, the diagnostic apparatus may be configured to execute the diagnostic program code in the data processor.

The diagnostic program code may be configured to retrieve the at least one selected system and/or diagnostic value and/or process value of the field devices of the cluster of field devices and to transmit the determined status information for the respective field device to the respective field device.

In other words, the diagnostic program code may be executed on the diagnostic apparatus itself. The diagnostic program code may then, for example, pilot the field devices to transmit the required system and/or diagnostic values and/or process values to the diagnostic apparatus. The diagnostic apparatus may then determine status information for each of the field devices from the transmitted values. This can, for example, take place by using a set of assignment regulations. The determined status information for each of the field devices of the cluster can then again be transmitted to the respective field devices of the cluster by the diagnostic apparatus, and the field devices of the cluster can be caused to indicate the status information using the signal generator.

According to one aspect, the diagnostic apparatus may thus pilot the respective field devices such that they output the status information using the associated signal generators. According to another aspect, the diagnostic apparatus may also immediately cause the/all field devices of the cluster to turn on a display on the signal generator corresponding to the determined status information of the respective field device.

According to a further aspect, the diagnostic apparatus may be configured to transmit a diagnostic program code (or part of the diagnostic program code) to several of the field devices. The field devices may be configured to execute the transmitted diagnostic program code in their respective data processing devices.

According to a further advantageous aspect, the diagnostic program code may be selected from a plurality of diagnostic program codes. The plurality of diagnostic program codes can be stored in a memory of the data processor of the diagnostic apparatus and/or in a memory of the data processing device of the respective field devices.

In other words, the diagnostic apparatus can, for example, select a specific diagnostic program code from different diagnostic program codes on the respective field devices depending on the common selection criterion and execute it on the field device, more specifically in the data processing device of the field device. The corresponding values can thus be processed on the field device. The result of the processing can be transmitted to the diagnostic apparatus. The assignment of the status information can take place on the diagnostic apparatus.

However, it is alternatively possible to process the values on the field device, wherein it is also possible to carry out the assignment of status information directly on the field device. A transmission of the corresponding values in the diagnostic apparatus may then be omitted.

The values and in particular the status information can nevertheless be transmitted to the diagnostic apparatus. In this way, a representation can advantageously take place in a central place.

According to a further advantageous aspect, the diagnostic apparatus may be configured to set parameters of the diagnostic program code on the basis of the user inputs at the human-machine interface.

According to a further advantageous aspect, the field devices may each include a diagnostic mode. In the diagnostic mode, the field devices may output the respectively determined status information using the associated signal generators.

After termination of the diagnostic mode, the signal generators can output a signal last output before the beginning of the diagnostic mode. In other words, the signal generators return to their previous operating state after an end of the diagnostic mode.

According to a further advantageous aspect, the diagnostic apparatus may be configured to activate the diagnostic mode on the respective field devices.

The diagnostic program code may also be configured to activate the diagnostic mode on the respective field devices.

According to a further advantageous aspect, the diagnostic mode may be self-ending after a predetermined period of time. The predetermined period of time can be based on the user inputs at the human-machine interface or can be determined by the diagnostic apparatus. The predetermined period of time can in particular depend on system and/or diagnostic values and/or process values of the field devices and/or on a number of the field devices. The period of time is thus adapted to the expected time needed for maintenance.

According to a further advantageous aspect, the diagnostic mode of the respective field devices may be configured to be terminated by the diagnostic apparatus. The diagnostic apparatus may be configured to terminate the diagnostic modes of the field devices. The diagnostic mode can thus already be terminated before the automatic lapse of time.

According to a further advantageous aspect, at least some of the field devices of the cluster may each have an operating device. The diagnostic mode of the field devices may be configured to be terminated by an appropriate user input at one of the operating devices. The diagnostic mode of the respective field devices may in particular be terminated by an appropriate user input at the operating device of the respective field device. In other words, the diagnostic mode of a field device can be terminated by an appropriate user input directly at the field device.

Alternatively or additionally, the field devices may be configured such that the diagnostic modes of all field devices are terminated by an appropriate user input at the operating device of one of the field devices. In other words, all field devices may be terminated jointly by an appropriate user input at the operating device of one of the field devices.

According to a further advantageous aspect, the system may be configured such that a termination of the diagnostic mode of a first field device initiates an activation of the diagnostic mode of a second field device. In other words, the diagnostic mode of a second field device can be activated as soon as the diagnostic mode on a first field device is terminated. The same applies of course not only for the first and the second field device, but for all further field devices of the cluster such that (only) one field device is respectively in the diagnostic mode and the diagnostic modes of the field devices are activated sequentially.

Furthermore, a method of selecting and identifying field devices from a plurality of field devices is provided.

According to one aspect, the method comprises the selection of at least one corresponding system and/or diagnostic value and/or process value of the respective field devices on the basis of a common selection criterion. The selection may in particular be based on user inputs at a human-machine interface of a diagnostic apparatus.

According to an advantageous aspect, the method can furthermore comprise the creation of a diagnostic program code or the selection of the diagnostic program code from a plurality of diagnostic program codes and/or the parametrizing of a diagnostic program code on the basis of the common selection criterion.

According to a further advantageous aspect, the method can comprise the selection of the diagnostic program code from a plurality of diagnostic program codes in the data processing devices of the field devices and/or the parametrizing of the diagnostic program code in the data processing device of the respective field devices.

According to a further advantageous aspect, the method can comprise the transmission of the diagnostic program code from the data processor of the diagnostic apparatus into the data processing device of the field devices.

According to a further aspect, the method comprises the determination of status information for the respective field device on the basis of the at least one corresponding system and/or diagnostic value and/or process value which corresponds to the selection criterion.

According to an advantageous aspect of the invention, the method can further comprise the execution of the diagnostic program code for determining the status information for the respective field devices, in particular in the data processor of the diagnostic apparatus or in the data processing device of the field devices.

According to a further advantageous aspect of the invention, the method can comprise the determination of the status information for the respective field device from a plurality of possible status information.

In a set of assignment regulations, status information among possible status information may be respectively assigned to the defined values and/or ranges of values of the corresponding system and/or diagnostic values and/or process values.

The diagnostic program code may in particular comprise the set of assignment regulations.

According to a further advantageous aspect, the method may comprise the execution of the diagnostic program code in the data processing devices of the respective field devices.

According to a further advantageous aspect, the method may comprise the activation of the diagnostic mode of at least one of the field devices and in particular of the diagnostic modes of all field devices of a field device cluster. The activation of the diagnostic mode(s) may in particular be carried out by the diagnostic apparatus.

The method may in particular also comprise the activation of the diagnostic mode of one of the field devices, in particular by the diagnostic apparatus and/or by the field device and/or by a user input at the field device and/or by a further field device and/or by a user input at the further field device.

According to a further aspect, the method comprises the output of the respective status information by a signal generator assigned to the respective field device. The method in particular comprises the output of the respective status information in a diagnostic mode of the field devices.

According to a further advantageous aspect of the invention, the method can comprise the automatic termination of the diagnostic mode after a predetermined period of time and/or the termination of the diagnostic mode by the diagnostic apparatus and/or the termination of the diagnostic mode by the respective field device. The diagnostic mode may in particular be terminated after the fulfillment of a condition and/or after a user input at the diagnostic apparatus or at one of the field devices.

### BRIEF DESCRIPTION OF THE DRAWINGS

The features and aspects of the invention will be explained in detail below on the basis of example embodiments and with reference to the figures which show:

FIG. 1 is a simplified schematic representation of a field bus system including field devices and a diagnostic apparatus,

FIG. 2 is a simplified schematic representation of a field bus system including field devices and a diagnostic apparatus,

FIG. 3 is a simplified schematic representation of a field bus system including field devices and a diagnostic apparatus,

FIG. 4a to FIG. 4f are a sequential simplified schematic representation of a field bus system including field devices and a diagnostic apparatus,

FIG. 5a to FIG. 5d are a sequential simplified schematic representation of a field bus system including field devices and a diagnostic apparatus,

FIG. 6a to FIG. 6f are a sequential simplified schematic representation of a field bus system including field devices and a diagnostic apparatus.

### DETAILED DESCRIPTION

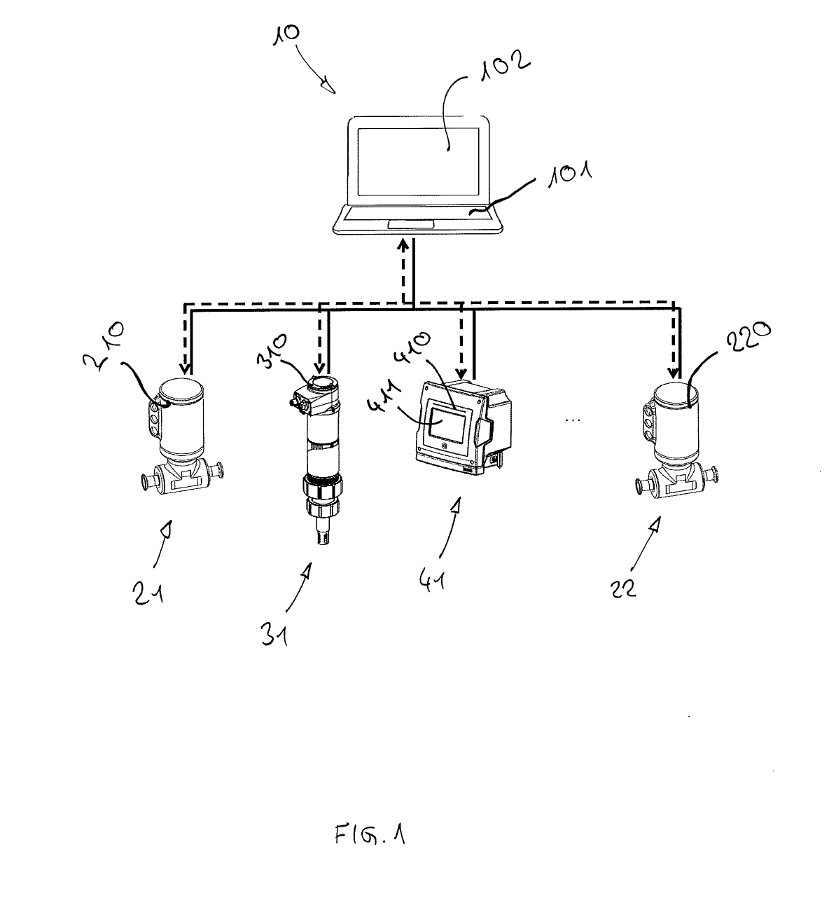

FIG. 1 shows a simplified schematic representation of a field bus system including a first to a fourth field device 21, 22, 31, 41 and a diagnostic apparatus 10.

The field devices 21, 31, 41, 22 and the diagnostic apparatus 10 are connected via a field bus. The field bus may for example be a Bürkert büS.

The first field device 21 and the second field device 22 each have an associated signal generator 210 and 220. In this case, the signal generator is a luminous ring backlit by LEDs. The third field device 31 also has a luminous ring 310. In addition to a display 411, the fourth field device 41 has a luminous strip 410 as a signal generator. The signal generators 210, 220, 310, 410 may be piloted by data processing devices of the field devices 21, 22, 31, 41 and output different luminous colors. The luminous color of the color signals can be specified via the bus system by using status information (output instructions).

The diagnostic apparatus 10 (in the present case a portable PC/laptop having, for example, a keypad 101 and a display 102) is temporarily connected to the bus system. A diagnostic program code which comprises, for example, an operating hour interrogation, an activation period and luminous colors assigned to numbers of operating hours is created using the diagnostic apparatus. The luminous color green is, for example, assigned to a number of operating hours of less than 100 hours. The luminous color red is assigned to a number of operating hours of more than 300 hours. The luminous color yellow is provided for a number of operating hours between these two values, i.e. over 100 but below 300 hours.

In a next step, (at least parts) of the diagnostic program or the entire diagnostic program is/are transmitted from the diagnostic apparatus 10 via the bus system to the field devices 21, 22, 31, 41 and is/are then executed there.

The numbers of operating hours on the field devices are retrieved by the part of the diagnostic program code for the operating hour interrogation and are transmitted to the diagnostic apparatus. For each field device, appropriate luminous colors are assigned to the numbers of operating hours by using the evaluation routine of the diagnostic program code in the diagnostic apparatus. Status information corresponding to the luminous colors are transmitted by the diagnostic apparatus 10 to the field devices 21, 22, 31, 41 and activate there the respective signal generators 201, 220, 210 and 410 for the duration of the activation period.

A service employee can in this way identify directly in the installation field devices which require a maintenance after a specific number of operating hours on the basis of the color signals. At the end of the activation period, the output of the field devices switches back to their normal display. Alternatively, the service employee can also turn off the diagnostic display on one of the field devices manually as soon as the maintenance has been completed.

FIG. 2 shows a simplified schematic representation of a field bus system having field devices 21, 22, 41, 31, 42 and a diagnostic apparatus 10. The field bus system is in essential points comparable with that of FIG. 1.

The system comprises a plurality of field devices 21, 22, 41, 31, 42 each having a signal generator 210, 220, 410, 310, 420 assigned to the respective field device 21, 22, 41, 31, 42.

For reasons of a better presentability, the signal generators 210 to 410 are shown as traffic lights having three different signal states (plus “off”). The respectively assigned signal generators 210 to 420 may be arranged in, on, or at the respective field devices 21 to 42.

The field devices each have a communication interface and a data processing device for providing system values, diagnostic values and/or process values.

The system is configured to selectively choose at least one corresponding system and/or diagnostic value and/or process value of the respective field devices on the basis of a common selection criterion. In the example embodiment shown, the common selection criterion is the type of the respective field devices. The first and the second field device 21, 22 are thus identical in design, just as the third and the fifth field device 41, 42.

The system is further configured to determine status information for the respective field device on the basis of the at least one respectively selected system and/or diagnostic value and/or process value (here: the type of the field devices) and to output it using the associated signal generators.

In the concrete example, the field devices 21, 22 and 41, 42 which are respectively identical in design, include appropriate status information. The signal generator 210 associated with the first field device 21 signalizes the status red 213. The signal generator 220 associated with the second field device 22 also correspondingly signalizes the red status information 223 due to the identical design of the field devices. The signal generators 410, 420 of the third and the fifth field device 41, 42 behave entirely in accordance therewith. They signalize the status information green 411, 421. The signal generator 310 associated with the fourth field device 31 signalizes the status information yellow 312.

The system furthermore comprises a diagnostic apparatus 10 having a data processor, a communication interface, and a human-machine-interface, wherein the diagnostic apparatus is configured to exchange information with the respective field devices 21, 22, 41, 31, 42 and to selectively choose the system and/or diagnostic values and/or process values of the respective field devices corresponding to the selection criterion on the basis of user inputs at the human-machine interface. The system value was selected here as corresponding value to the common selection criterion.

The system further comprises a diagnostic program code 11. The diagnostic program code is configured to be executed by the data processor of the diagnostic apparatus 10.

The diagnostic program code 11 is configured to retrieve, process and/or change the at least one selected system value type of the field devices 21, 22, 41, 31, 42.

The status information 213, 223, 411, 312, 421 for the respective field devices 21, 22, 41, 31, 42 is thus determined from the at least one selected system and/or diagnostic value and/or process value type of the field devices. The diagnostic program code 11 comprises processing instructions, data structures and/or parameters. In the present case, the diagnostic program code is a binary code which is directly executed by the data processor of the diagnostic apparatus.

The diagnostic apparatus 10 is configured to create the diagnostic program code 11 on the basis of the user inputs in the human-machine interface or to select it from a plurality of other diagnostic program codes.

The diagnostic program code 11 is configured to retrieve the at least one selected system and/or diagnostic value and/or process value of the respective field devices (here the field device type) from the respective field devices and to transmit the determined status information for the respective field device to the respective field device.

The diagnostic apparatus 10 is configured to transmit the diagnostic program code 11 to a plurality of the field devices. The field devices 21, 22, 41, 31, 42 are appropriately configured to execute the diagnostic program code 11 in the data processing device.

The diagnostic program code 11 may be selected from a plurality of diagnostic program codes or may, for example, be created due to a template (program code base structure) and by using parametrizing. The parameters in the diagnostic program code are based on the user inputs at the human-machine interface.

The field devices 21, 22, 41, 31, 42 each have a diagnostic mode. In the diagnostic mode, the signal generator 210, 220, 410, 310, 420 respectively assigned to the field device outputs the status information 213, 223, 411, 312, 421 assigned to the respective field device. The diagnostic apparatus 10 is configured to activate the diagnostic mode on the respective field devices 21, 22, 41, 31, 42. The diagnostic program code 11 is in particular configured to activate the diagnostic mode on the respective field devices.

According to one example embodiment, the diagnostic mode may be configured to be self-ending after a predetermined period of time. The predetermined period of time can advantageously be based on the user inputs at the human-machine interface or can be determined by the diagnostic apparatus. According to one example embodiment, the predetermined period of time can advantageously depend on system and/or diagnostic values and/or process values of the field devices and/or on a number of the field devices.

According to a further example embodiment, the diagnostic mode of the respective field devices 21, 22, 41, 31, 42 may be configured to be terminated by the diagnostic apparatus 10. The diagnostic apparatus 10 may then be appropriately configured to terminate the diagnostic modes of the field devices.

The field devices 21, 22, 41, 31, 42 each have an operating device (not shown). In an example embodiment, the diagnostic mode of the field devices may advantageously be configured to be terminated by an appropriate user input at one of the operating devices.

The diagnostic mode of the respective field devices can in particular be terminated by an appropriate user input at the operating device of the respective field device. The field devices can additionally or alternatively be configured such that the diagnostic modes of all field devices 21, 22, 41, 31, 42 are terminated by using an appropriate user input at the operating device of one of the field devices.

In a further embodiment, the termination of the diagnostic mode of a first field device can initiate an activation of the diagnostic mode of a second field device.

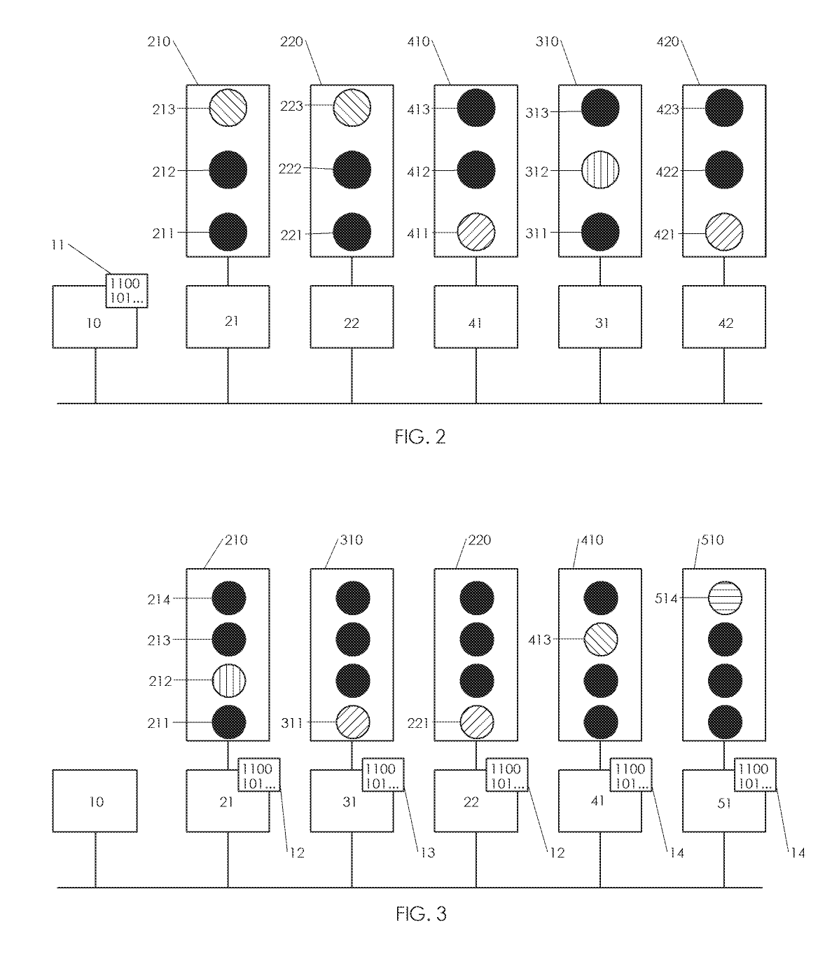

FIG. 3 shows a simplified schematic representation of a field bus system including field devices and a diagnostic apparatus.

The structure of the configuration of the system corresponds in the essential features to the structure and the configuration of the system of FIG. 2. Merely the differences are therefore explained individually below.

The signal generators 210, 310, 220, 410, 510 assigned to the respective field devices 21, 31, 22, 41, 51 can signalize more than three different status information. More specifically, optical signal generators are involved which are, for example, adapted to signalize four or six different status information in accordance with the NAMUR specification NE107. They include blue (maintenance recommended), orange (signal invalid), yellow (process out of fixed specifications), and red (continued malfunction of the field device). It is further possible to use the two further colors (green and white) for activating the diagnostic function.

The diagnostic program codes 12, 13, 14 are configured to be respectively executed by the data processing device of one of the field devices.

Field devices 21, 22 of identical design and field devices including the same control unit 41, 51 respectively have uniform diagnostic program codes 12 and 14. The diagnostic program code is configured to retrieve, process and/or change the at least one selected system and/or diagnostic value and/or process value of the respective field device of the cluster.

The diagnostic apparatus 10 is configured to create the diagnostic program codes 12, 13, 14 on the basis of the user inputs at the human-machine interface or to select it from a plurality of diagnostic program codes.

The diagnostic apparatus 10 is further configured to transmit the respective diagnostic program code 12, 13, 14 to several of the field devices 21, 22 or 41, 51. The field devices are configured to execute the diagnostic program code in the data processing device.

The diagnostic program codes 12, 13, 14 are each stored in a memory of the data processing device of the respective field devices. A parametrizing is carried out by the diagnostic apparatus 10 directly in the data processing devices of the respective field devices.

Further combinations of the example embodiments are possible. Only parts of the diagnostic program code 11 are loaded into the respective field devices to transmit the corresponding values from there to the diagnostic program, either in a processed or unprocessed form, and to pilot the signal generators 210, 310, 220, 410, 510 of the appropriate field devices by the diagnostic apparatus 10.

It is also possible that no diagnostic program codes are transmitted to the field devices by the diagnostic apparatus 10 and that the diagnostic apparatus directly pilots the respective field devices via the diagnostic program. Pilot directly means here that the signal generator of the field device is directly set by the diagnostic apparatus 10 or that the field device fixes itself the display of the signal generator on the basis of a code implemented there.

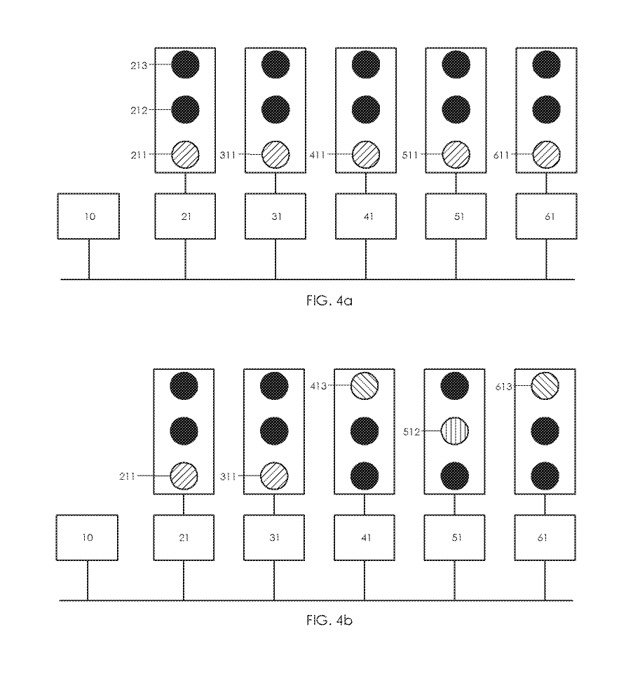

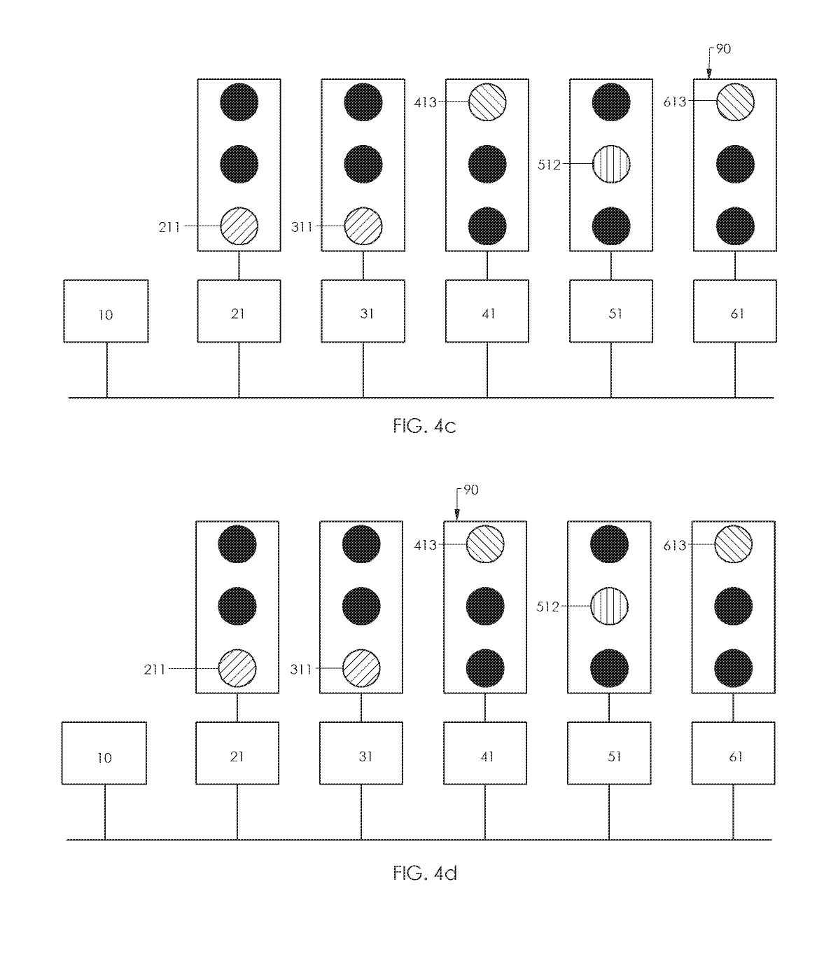

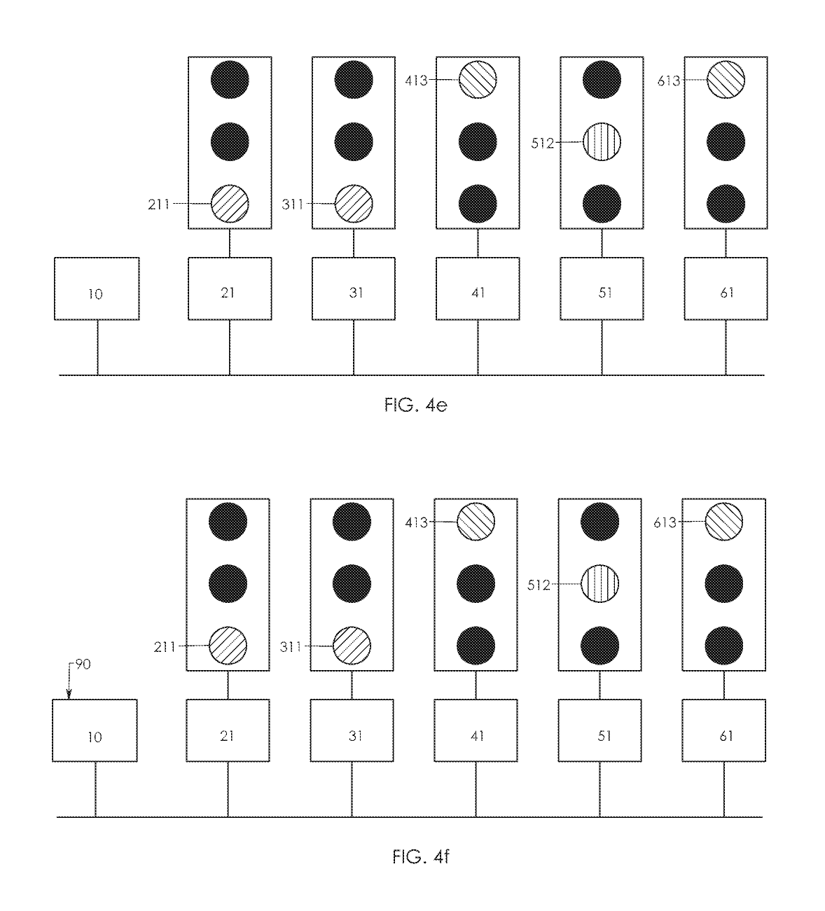

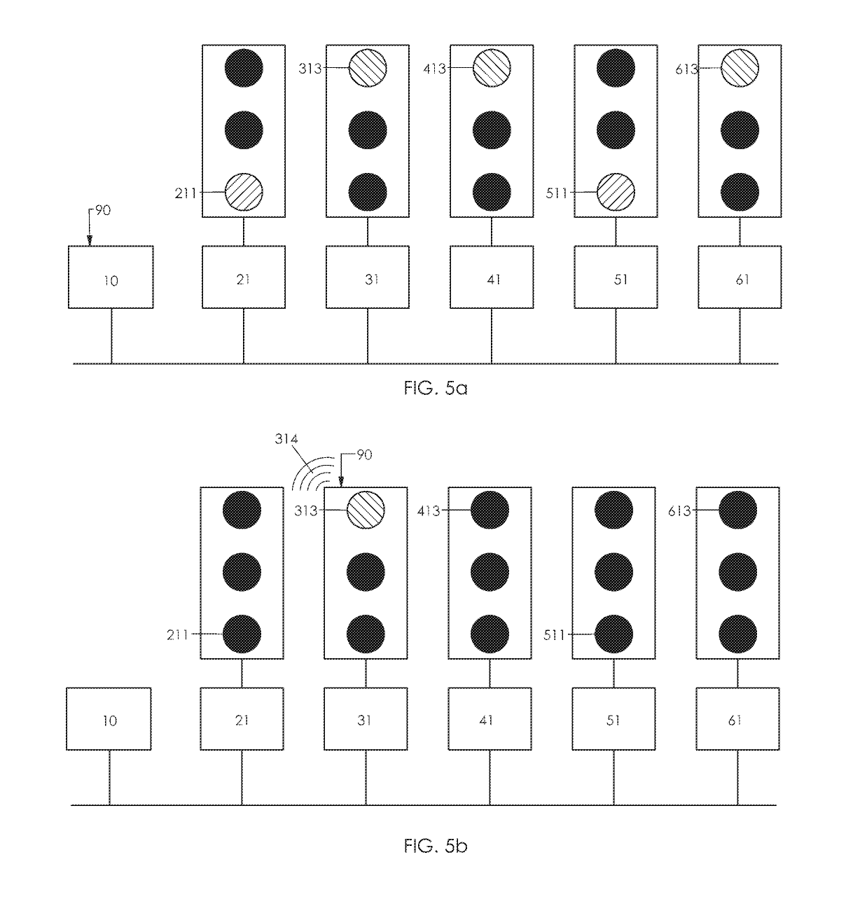

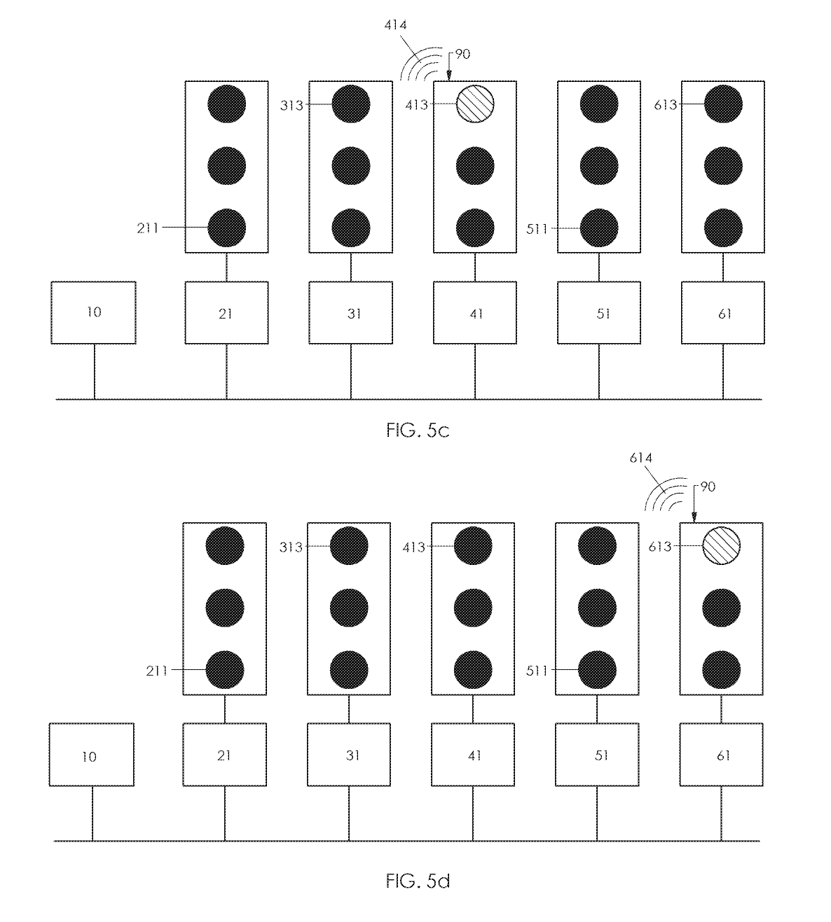

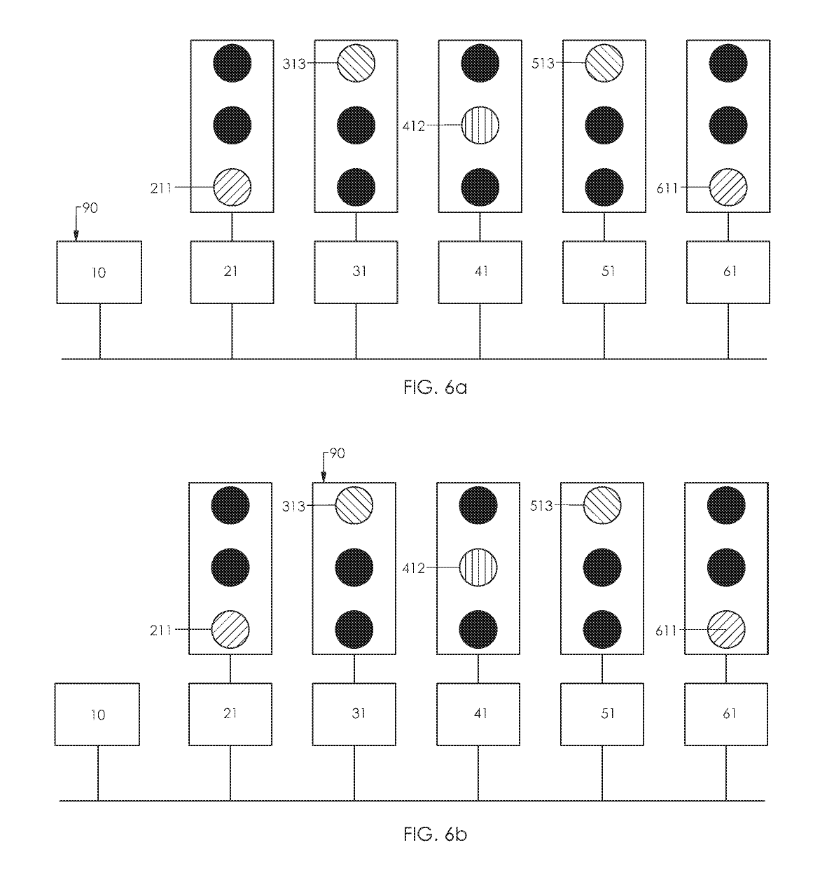

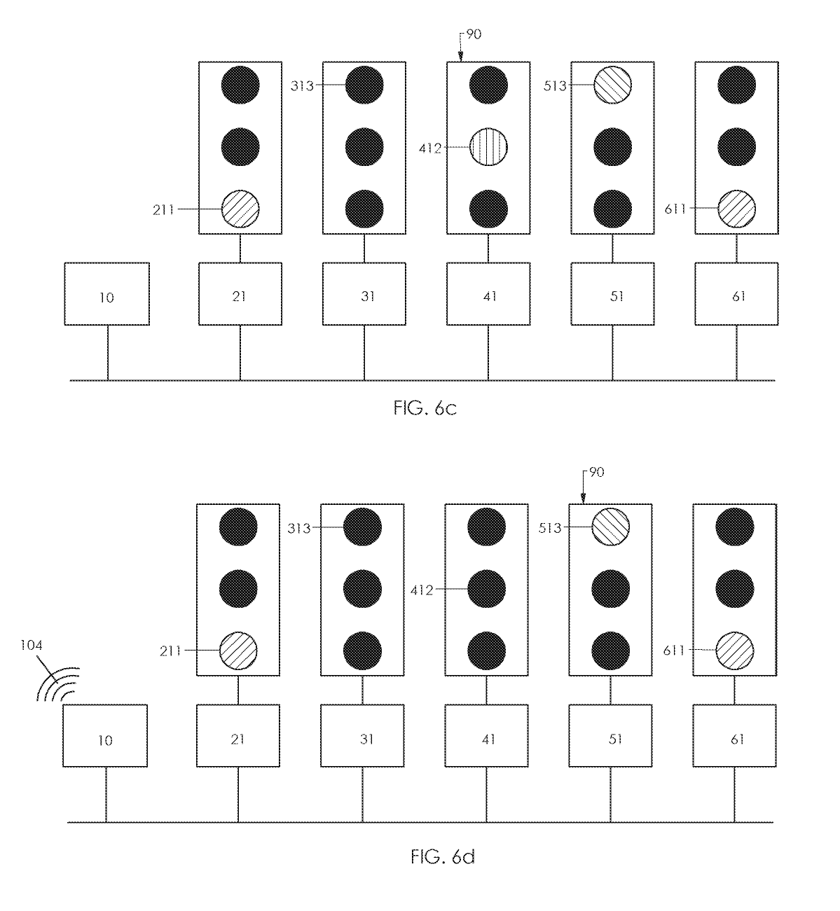

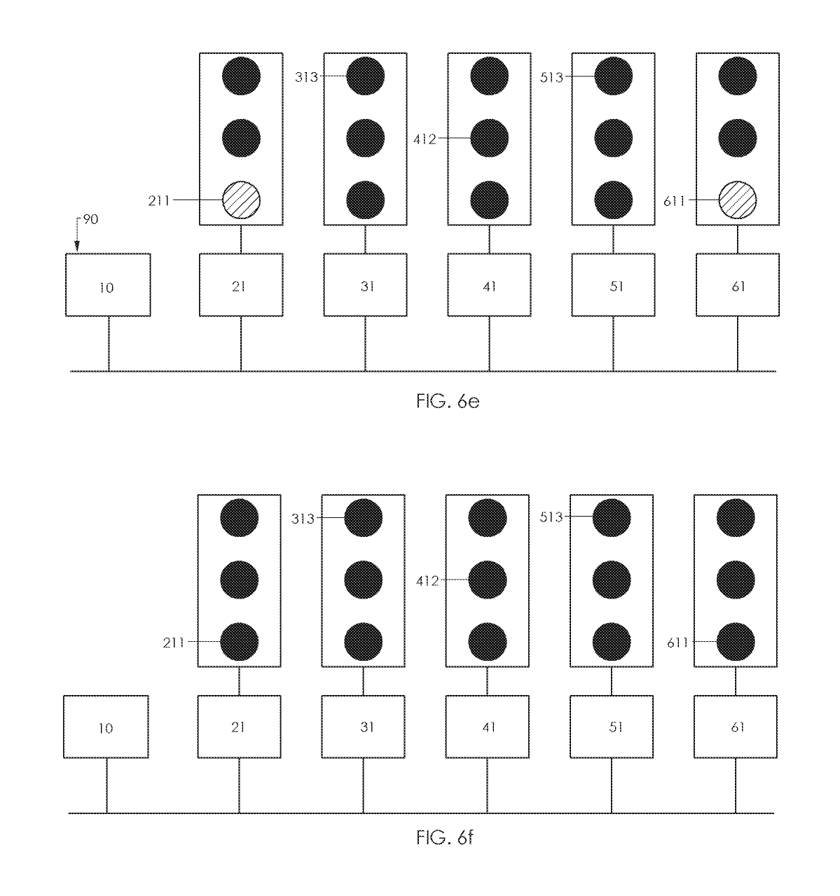

The method is to be described below with reference to the sequences of FIG. 4a to FIG. 4f, of FIG. 5a to FIG. 5d, and of FIG. 6a to FIG. 6f.

FIG. 4a to FIG. 4f show a sequential schematic representation of a field bus system including field devices and a diagnostic apparatus. The field bus system including the field devices and the diagnostic apparatus substantially corresponds to that of FIGS. 1 to 3. In a normal operating state, the signal generators can each be deactivated (not shown) or for example display the operating mode (FIG. 4a).

At least one corresponding system and/or diagnostic value and/or process value of the respective field devices is selected at the diagnostic apparatus 10 on the basis of a common selection criterion. This is carried out on the basis of user inputs at a human-machine interface of the diagnostic apparatus.

The method further comprises the determination of status information for the respective field device of the cluster on the basis of the at least one corresponding system and/or diagnostic value and/or process value. The common selection criterion may, for example, be the remaining residual service life of the field devices. In another case, the common selection criterion can relate to process values, for example upon putting the system into operation. Depending on the field device, a flow (flowmeter), a pH value (ph-value sensor) or a valve position (valve) may be involved. In a further step, the output of the respective status information 211, 311, 413, 512, 613 is carried out by a signal generator assigned to the respective field device.

The method further comprises the creation of a diagnostic program code or the selection of the diagnostic program code from a plurality of diagnostic program codes (not shown). It may alternatively or additionally also comprise the parametrizing of a diagnostic program code on the basis of the common selection criterion.

The method further comprises the execution of the diagnostic program code to determine the status information for the respective field devices 21, 31, 41, 51 and 61. The diagnostic program code(s) can in particular be executed in the data processor of the diagnostic apparatus or in the data processing device of the respective field devices.

The method further comprises the determination of status information for the respective field device from a plurality of possible status information. Status information among the possible status information is respectively assigned to the defined values and/or ranges of values of the corresponding system and/or diagnostic values and/or process values in a set of assignment regulations. The diagnostic program code in particular comprises the set of assignment regulations.

The method further comprises the transmission of the diagnostic program code from the data processor of the diagnostic apparatus 10 to the data processing device of the field devices 21, 31, 41, 51 and 61.

Alternatively, the method can also comprise the selection of the diagnostic program code from a plurality of diagnostic program codes in the data processing devices of the field devices and/or the parametrizing of the diagnostic program code in the respective data processing device.

In this case, the method comprises the execution of the diagnostic program code in the data processing devices of the respective terminal devices.

FIG. 4b shows the activation of the diagnostic mode in all field devices of a field device cluster. A field device cluster is regarded as a plurality of field devices, wherein these devices may, for example, be grouped due to their local arrangement. For example, all field devices of a specific production process or all field devices in a specific space can, for example, belong to a field device cluster.

All field devices represented in FIG. 4b are assigned to a common field device cluster.

FIG. 4c to FIG. 4f show in a sequence of chronological order the course of action of the service employees 90 during maintenance. In the diagnostic mode, the service employee 90 can immediately have an overview of the status information of the respective field devices.

The service employee therefore turns to the spatially closest field device 61 having a high priority 613 (FIG. 4c).

In the following steps, the service employee also maintains the field devices 41 with status information three 413 (FIG. 4d) and field device 51 with status information two 512. The field devices 21, 31 do not require any maintenance and show this by the appropriate status information one 211 and 311 (FIG. 4e).

The service employee 90 can thus return to the diagnostic apparatus and there terminate the diagnostic modes of all field devices 21, 31, 41, 51, 61 by a user input.

Alternatively, the diagnostic apparatus can also determine in an autarkic manner whether, for example, a maintenance at all relevant field devices was carried out such that the diagnostic mode of each field device is thus terminated.

Finally, the diagnostic mode can also be terminated through the expiration of a predetermined period of time either by the diagnostic apparatus or by the field devices themselves.

The system then returns back to its original state (FIG. 4a).

FIG. 5a to FIG. 5d also show the method in a time sequence, differences lying here in particular in the activation and termination of the diagnostic modes.

It can be seen that the common selection criterion also differs from that in the previous example embodiments. This finds expression, among others, in the differing status information (FIG. 5a). The selection criterion can accordingly be selected by the user in a demand-oriented manner from a plurality of different selection criteria.

The diagnostic apparatus 10 determines the status information for the respective field devices. Afterwards, it activates the diagnostic mode of the first field device 31 with appropriate status information 313. Apart from a visual signaling 313, an acoustic signaling 314 is also activated (FIG. 5b). The acoustic signaling supports the service employee 90 in carrying out a coarse location of the field device 31. By the visual signaling 313, it is in turn possible to quickly find the correct field device in loud environments.

When the service employee 90 has terminated the maintenance of field device 31, he/she can deactivate the diagnostic mode by the respective field device 31, in particular by using a user input.

The diagnostic mode of field device 41 is automatically activated by the termination of the diagnostic mode of field device 31 (FIG. 5c).

After having also carried out the maintenance here, the respective field device independently terminates the diagnostic mode, for example after the fulfillment of a condition (here the completion of the maintenance work).

By the termination of the diagnostic mode for the field device 41, the diagnostic mode for the last field device 61 is activated (FIG. 5d). The diagnostic apparatus 10 can signalize the end of the procedure to the service employee 90 after the termination of the maintenance work.

FIG. 6a to FIG. 6f represent a comparable method. In addition to a different selection criterion, it is visible here in the sequence that the service employee 90 first activates the diagnostic mode at all field devices (FIG. 6a) and then individually deactivates the diagnostic mode at these devices at the end of an inspection operation at the respective field device (FIG. 6b, FIG. 6c, FIG. 6d).

As the remaining field devices 21 and 61 only signalize 211, 611 the first status information, the service employee terminates the diagnostic mode of all remaining field devices (FIG. 6e).

The field devices return back to their normal operating state; in this case, the signal generators are deactivated (FIG. 6f).

1. A system comprising:
a cluster of field devices each having a signal generator assigned to a respective field device;
a communication interface;
a data processing device for provision of system values, diagnostic values, and/or process values; and
wherein the system is configured to selectively choose at least one corresponding system and/or diagnostic value and/or process value of the respective field devices on a basis of a common selection criterion, and the system is configured to determine status information for the respective field device on a basis of the at least one respectively selected system and/or diagnostic value and/or process value and to output the status information using the assigned signal generator.

2. The system according to claim 1, comprising a diagnostic apparatus having a data processor, a communication interface, and a human-machine interface, wherein the diagnostic apparatus is configured to exchange information with the respective field devices, and to selectively choose the corresponding system and/or diagnostic values and/or process values of the respective field devices on a basis of user inputs at the human-machine interface and in accordance with the common selection criterion.

3. The system according to claim 2, comprising a diagnostic program code, wherein the diagnostic program code is configured to be executed by the data processor of the diagnostic apparatus and/or by the data processing device of one of the field devices,
wherein the diagnostic program code is further configured to retrieve, to process and/or to change the at least one selected system and/or diagnostic value and/or process value of said field device, and to determine the status information for said field device from the at least one selected system and/or diagnostic value and/or process value of said field device,
in particular wherein the diagnostic program code comprises processing instructions, data structures and/or parameters.

4. The system according to claim 3, wherein the diagnostic apparatus is configured to create the diagnostic program code on the basis of the user inputs at the human-machine interface or to select the diagnostic program code from a plurality of diagnostic program codes.

5. The system according to claim 4, wherein the diagnostic apparatus is configured to execute the diagnostic program code in the data processor, and wherein the diagnostic program code is configured to retrieve the at least one selected system and/or diagnostic value and/or process value of the respective field devices from the respective field devices and to transmit determined status information for the respective field device to the respective field device.

6. The system according to claim 4, wherein the diagnostic apparatus is configured to transmit the diagnostic program code to several of the field devices, and wherein the field devices are configured to execute the diagnostic program code in the data processing device.

7. The system according to claim 4, wherein the diagnostic program code is selected from the plurality of diagnostic program codes, and wherein the plurality of diagnostic program codes is stored in a memory of the data processor of the diagnostic apparatus and/or in a memory of the data processing device of the respective field devices.

8. The system according to claim 3, wherein the diagnostic apparatus is configured to set parameters in the diagnostic program code on the basis of the user inputs at the human-machine interface.

9. The system according to claim 2, wherein the field devices each have a diagnostic mode, wherein in the diagnostic mode, the signal generator assigned to the respective field device outputs the status information,
in particular wherein the data processing device of the respective field device is configured to pilot the associated signal generator such that the signal generator outputs the status information in the diagnostic mode, and
in particular wherein after termination of the diagnostic mode, the signal generator outputs a signal last output before a beginning of the diagnostic mode.

10. The system according to claim 9, wherein the diagnostic apparatus is configured to activate the diagnostic mode on the respective field devices and/or wherein the diagnostic program code is configured to activate the diagnostic mode on the respective field devices.

11. The system according to claim 9, wherein the diagnostic mode is self-ending after a predetermined period of time,
in particular wherein the predetermined period of time is based on the user inputs at the human-machine interface or is determined by the diagnostic apparatus and in particular depends on system and/or diagnostic values and/or process values of the field devices and/or on a number of the field devices, and/or wherein the diagnostic mode of the respective field devices is configured to be terminated by the diagnostic apparatus, and wherein the diagnostic apparatus is configured to terminate the diagnostic modes of the field devices and/or the field devices each have an operating device, and wherein the diagnostic mode of the field devices is configured to be terminated by an appropriate user input at one of the operating devices, in particular wherein the diagnostic mode of the respective field devices is terminated by an appropriate user input at the operating device of the respective field device, and/or wherein the field devices are configured such that the diagnostic modes of all field devices are terminated by an appropriate user input at the operating device of one of the field devices.

12. The system according to claim 9, wherein a termination of the diagnostic mode of a first field device initiates an activation of the diagnostic mode of a second field device.

13. A method of selecting and identifying field devices from a cluster of field devices, the method comprising the steps of:
a) selecting at least one corresponding system and/or diagnostic value and/or process value of the respective field devices on a basis of a common selection criterion, in particular on a basis of user inputs at a human-machine interface of a diagnostic apparatus,
e) determining status information for the respective field device on a basis of the at least one corresponding system and/or diagnostic value and/or process value, and
g) outputting the respective status information of all field devices of the cluster by a signal generator assigned to the respective field device, in particular in a diagnostic mode of the field devices.

14. The method according to claim 13, comprising the steps of:
b) creating a diagnostic program code or selecting the diagnostic program code from a plurality of diagnostic program codes, and/or parametrizing a diagnostic program code on the basis of the common selection criterion, in particular after step a), in particular by a data processor of the diagnostic apparatus,
e1) executing the diagnostic program code for determining the status information for the respective field devices, in particular after step e), in particular in the data processor of the diagnostic apparatus or in the data processing devices of the respective field devices,
and/or
e2) determining the status information for the respective field device from a plurality of possible status information, wherein status information of the possible status information is respectively assigned to defined values and/or ranges of values of the system and/or diagnostic values and/or the process values corresponding to the selection criterion in a set of assignment regulations, in particular in step e), in particular wherein the diagnostic program code includes the set of assignment regulations,
and/or
c) transmitting the diagnostic program code from the data processor of the diagnostic apparatus into the data processing device of the field devices, in particular after step b), in particular before step e), or alternatively
b2) selecting the diagnostic program code from a plurality of diagnostic program codes in the data processing devices of the field devices and/or parametrizing the diagnostic program code in the data processing device of the respective field devices, in particular in step b), and
e3) executing the diagnostic program code in the data processing devices of the respective field devices, in particular in step e).

15. The method according to claim 13, comprising the steps of:
f1) activating the diagnostic mode of at least one of the field devices, in particular before step g), in particular the diagnostic modes of all field devices of a field device cluster, in particular by the diagnostic apparatus, or
f2) activating the diagnostic mode of one of the field devices, in particular before step g), in particular by the diagnostic apparatus, and/or in particular by the field device, and/or in particular by a user input at the field device, and/or in particular by a further field device, and/or in particular by a user input at the further field device,
and/or
h1) automatically terminating the diagnostic mode after a predetermined period of time, in particular after step g), and/or
h2) terminating the diagnostic mode by the diagnostic apparatus, in particular after a user input and/or after the fulfillment of a condition, in particular after step g), and/or
h3) terminating the diagnostic mode by the respective field device, in particular after a user input and/or after the fulfillment of a condition, in particular after step g).
